(19) United States
(12) Patent Application Publication
(10) Pub. No.: US 2010/0002952 A1
(43) Pub. Date: Jan. 7, 2010

(54) METHOD AND APPARATUS FOR IMAGE SHARPENING

(75) Inventors: Munenori Oizumi, Tsuchiura-shi (JP); Kaori Koto (Urakoshi), Kokubunji-shi (JP)

Correspondence Address: TEXAS INSTRUMENTS INCORPORATED, P O BOX 655474, M/S 3999, DALLAS, TX, 75265, US

(73) Assignee: Texas Instruments Incorporated, Dallas, TX (US)

(21) Appl. No.: 12/496,487

(22) Filed: Jul. 1, 2009

Related U.S. Application Data
(60) Provisional application No. 61/077,306, filed on Jul. 1, 2008.

(51) Int. Cl. G06K 9/40

(52) U.S. Cl. 382/266

(57) ABSTRACT

A method and apparatus for image enhancement. The method includes measuring local activity of at least a portion of the image, utilizing the measured local activity for determining gradient at least a portion of the image, utilizing the determined gradient to enhance edges in at least a portion of the image, and utilizing the measured local activity of at least a portion of the image to limit edge enhancement intensity value range and to prevent halo in at least a portion of the image.

### CROSS-REFERENCE TO RELATED APPLICATIONS

This application claims benefit of U.S. provisional patent application Ser. No. 61/077,306, filed Jul. 1, 2008, which is herein incorporated by reference.

### BACKGROUND OF THE INVENTION

1. Field of the Invention

Embodiments of the present invention generally relate to a method and apparatus for image sharpening.

2. Description of the Related Art

The market of digital imaging is still rapidly growing. One of the largest areas in this field is still-image capturing, such as digital still cameras (DSCs) and camera cell phones.

In this field, there have been pressures for higher performance and lower cost, which result in demands for better imaging algorithms, such as, resolution enhancement. For example, low cost optical system often shows lower resolution than sensor resolution. Therefore, in order to reproduce the image quality comparable to the sensor spec, image enhancement algorithm is required. Also, mega-pixel race drove the market to CCD/CMOS sensors with 10-20 M pixel level. However, small sensors with large number of photo-cells are suffered from noises and cross-talks, and the resulting image often shows much lower resolution than its catalog numbers, especially under dark lighting conditions. Resolution enhancement is also required in such cases.

For this purpose of resolution enhancement, unsharp masking (USM) and its variations are widely used. However, USM based methods are known to produce bright and dark bands near edges, called Halo artifact. This artifact is disliked by some viewers, and need to be removed in some application.

There are other image sharpening methods, such as, convolution/de-convolution based ones, and wavelet based ones, which do not produce Halo artifacts. However, they all consume large amount of computational effort and memory.

Therefore, there is a need for an improved image sharpening method.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments. It should be noted, that a computer readable medium is any medium that can be accessed by a computer for reading, writing, executing, archiving and the like.

FIG. 1 is an embodiment depicting edge enhancement with unsharp masking (USM) compared to edge enhancement applied only to local changing gradient;

FIG. 2 is an embodiment depicting a block diagram for edge sharpening;

FIG. 3 is an embodiment depicting a block diagram for edge sharpening with local contras gain;

FIG. 4 is an embodiment depicting images improved utilizing USM, edge sharpening and edge sharpening with local contract gain; and

FIG. 5 is an embodiment depicting a flow diagram for a method for edge sharpening.

### SUMMARY OF THE INVENTION

Embodiments of the current invention relate to a method and apparatus for image enhancement. The method includes measuring local activity of at least a portion of the image, utilizing the measured local activity for determining gradient at least a portion of the image, utilizing the determined gradient to enhance edges in at least a portion of the image, and utilizing the measured local activity of at least a portion of the image to limit edge enhancement intensity value range and to prevent halo in at least a portion of the image.

### DETAILED DESCRIPTION

Edge sharpening method produces less Halo artifact and better output image quality. The image sharpening method only consumes about the same level of memory and computational effort as USM, which is much smaller than other edge sharpening methods without Halo artifact.

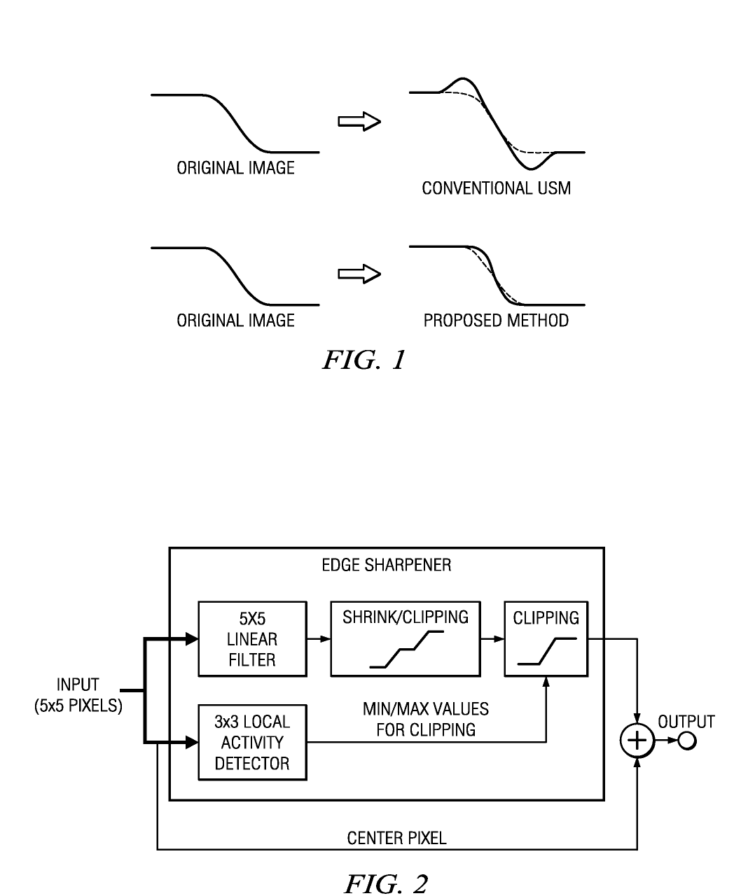

FIG. 1 is an embodiment depicting edge enhancement with unsharp masking (USM) compared to edge enhancement applied only to local changing gradient. It is beneficial to limit the area where edge enhancement is applied to the pixels where the surrounding gradient is finite. FIG. 1 shows the schematic effect from the conventional USM. The left side is a one dimensional projection of an edge in an image. The right side describes the effect from USM. As USM subtract low-pass filtered image from the original image, and then gain is controlled, the overall effect is comparable to adding high-pass filtered image. This causes over-shoot around edges which often results as Halo artifacts in the output images.

This image sharpening method applies edge enhancement to where the local gradient is changing. In one embodiment, the image sharpening method is made of three parts. One is measurement of local activity, which reflects the gradient of the surrounding area. The second is filtering, with HPF, to extract edges. The last process is to enhance the perceptual sharpness of the input image. At the last stage, the local activity measurement is used to limit the edge enhancement intensity value range, so that excessive edge enhancement that causes Halo artifact is prevented

The input image with width and height of hsize and vsize is represented by the following array.

input image={pⱼₖ: 0≦j<hsize,0≦k<vsize}

This image only contains luminance values. For full color image processing, luminance is first extracted from the original image, and the output image is merged with color information of the original image after this process is complete.

The image sharpening process is applied to each pixel, and this process uses 5×5 area of the each pixel. Therefore, the output image is represented as

output image={qⱼₖ:qⱼₖ=e({p_{j′k′}:j−2≦j′≦j+2,i−2≦i′≦i+2})}

Here, the function e is the key component of the edge enhancement method explained in this report, and will be explained in detail in the following sections. The pixels outside of the input image are extrapolated by an appropriate method such as copying of the pixels at the rims.

FIG. 2 is an embodiment depicting a block diagram for edge sharpening. The input to e is a 5×5 matrix, which is represented by the following matrix (I).

$$I = [ \begin{matrix}{p}_{j - 2 , k - 2} & {p}_{j - 1 , k - 2} & {p}_{j , k - 2} & {p}_{j + 1 , k - 2} & {p}_{j + 2 , k - 2} \\ {p}_{j - 2 , k - 1} & {p}_{j - 1 , k - 1} & {p}_{j , k - 1} & {p}_{j + 1 , k - 1} & {p}_{j + 2 , k - 1} \\ {p}_{j - 2 , k} & {p}_{j - 1 , k} & {p}_{j , k} & {p}_{j + 1 , k} & {p}_{j + 2 , k} \\ {p}_{j - 2 , k + 1} & {p}_{j - 1 , k + 1} & {p}_{j , k + 1} & {p}_{j + 1 , k + 1} & {p}_{j + 2 , k + 1} \\ {p}_{j - 2 , k + 2} & {p}_{j - 1 , k + 2} & {p}_{j , k + 2} & {p}_{j + 1 , k + 2} & {p}_{j + 2 , k + 2}\end{matrix} ]$$

The degree of local activity is measured by calculating values similar to gradients near the center pixel. These values are combined by the following equation to make the activity measurement value.

activity=min(|H₁(I_{sub})|,|H₂(I_{sub})|)+min(|V₁(I_{sub})|,|V₂(I_{sub})|).

Here, I_{sub} is a sub-matrix of I.

$${I}_{sub} = ( \begin{matrix}{p}_{j - 1 , k - 1} & {p}_{j , k - 1} & {p}_{j + 1 , k - 1} \\ {p}_{j - 1 , k} & {p}_{j , k} & {p}_{j + 1 , k} \\ {p}_{j - 1 , k + 1} & {p}_{j , k + 1} & {p}_{j + 1 , k + 1}\end{matrix} ) ,$$

and filters H1, H2, V1, V2 are made of the following kernels.

$$\begin{matrix}{H}_{1} = ( \begin{matrix}- 1 & 1 & 0 \\ - 2 & 2 & 0 \\ - 1 & 1 & 0\end{matrix} ) , {H}_{2} = ( \begin{matrix}0 & 1 & - 1 \\ 0 & 2 & - 2 \\ 0 & 1 & - 1\end{matrix} ) , \\ {V}_{1} = ( \begin{matrix}- 1 & - 2 & - 1 \\ 1 & 2 & 1 \\ 0 & 0 & 0\end{matrix} ) , {V}_{2} = ( \begin{matrix}0 & 0 & 0 \\ 1 & 2 & 1 \\ - 1 & - 2 & - 1\end{matrix} ) .\end{matrix}$$

### Therefore,

H₁(I_{sub})=(p_{j,k-1}+2p_{j,k}+p_{j,k+1})−(p_{j-1,k-1}+2p_{j-1,k}+p_{j-1,k+1}),

H₂(I_{sub})=(p_{j,k-1}+2p_{j,k}+p_{j,k+1})−(p_{j-1,k-1}+2p_{j+1,k}+p_{j+1,k+1}),

V₁(I_{sub})=(p_{j-1,k}+2p_{j,k}+p_{j-1,k})−(p_{j-1,k-1}+2p_{j,k-1}+p_{j+1,k-1}),

V₂(I_{sub})=(p_{j 1,k}+2p_{j,k}+p_{j+1,k})−(p_{j 1,k 1}+2p_{j,k+1}+p_{j+1,k+1}).

From this activity value, the limit value in edge detection stage will be derived.

The edge detection stage detects the edge near the center pixel, and derives the intensity for enhancement. The edge is detected by a 5×5 linear filter. For example, the following kernel may be used.

$$\begin{matrix}K = ( \begin{matrix}0 & - 1 & 0 \\ - 1 & 4 & - 1 \\ 0 & - 1 & 0\end{matrix} ) * ( \begin{matrix}1 & 2 & 1 \\ 2 & 4 & 2 \\ 1 & 2 & 1\end{matrix} ) \\ = ( \begin{matrix}0 & - 1 & - 2 & - 1 & 0 \\ - 1 & 0 & 2 & 0 & - 1 \\ - 2 & 2 & 8 & 2 & - 2 \\ - 1 & 0 & 2 & 0 & - 1 \\ 0 & - 1 & - 2 & - 1 & 0\end{matrix} ) .\end{matrix}$$

The output from this filter is multiplied by a gain value. Then, edge intensity becomes

$$edge = α {{\sum }_{- 2 \leq m \leq 2}}_{- 2 \leq n \leq 2} {K}_{m + 2 , n + 2} {p}_{j - m , k - n} ,$$

where α is a gain factor. Then, this value is processed by the following function to prevent enhancing noises.

$${edge}_{shrink} = shrink ( edge ) = \{ \begin{matrix}edge + thr & edge < - {SHR}_{-} THR \\ 0 & - {SHR}_{-} THR \leq edge \leq {SHR}_{-} THR \\ edge - thr & {SHR}_{-} THR < edge\end{matrix}$$

At the final stage, edge sharpening is applied to the original pixel. First, edge intensity value is clipped by min/max values derived from the local activity value to get the final sharpening intensity (e₁). This process limits the area of edge enhancement to where local activity value is finite.

$${e}_{1} = clip ( {edge}_{shrink} ) = \{ \begin{matrix}min & {edge}_{shrink} < min \\ {edge}_{shrink} & {edge}_{shrink} \\ max & max < {edge}_{shrink} .\end{matrix}$$

The minimum and maximum value (min and max) are derived from local activity value as below.

max=activity×gain+base

min=−max

The intensity value is added to the center pixel to enhance sharpness.

e(I)=p_{j,k}+e₁

Although the method described above achieves perceptual enhancement in image sharpness, it may lack enhancement in local contrast, which also has significant influence on perceptual image sharpness. In some cases, this lack of contrast enhancement results in dull impression to human eyes. To compensate this, the above method may be combined with a conventional USM based edge enhancement to achieve contrast enhancement in local area. In this case, the USM based edge enhancement can be tuned very weakly, because sharpness is already enhanced by the above method.

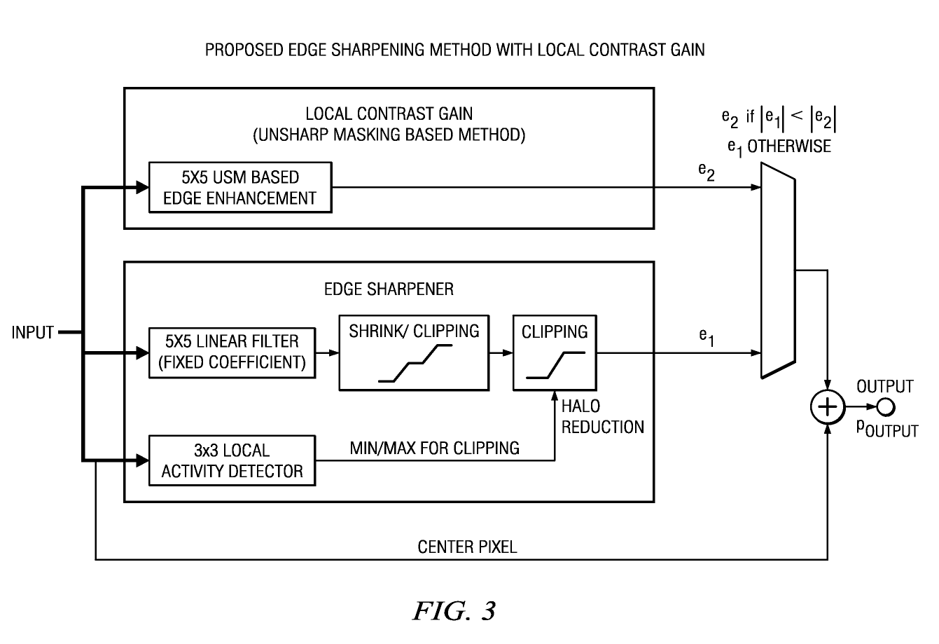

FIG. 3 is an embodiment depicting a block diagram for edge sharpening with local contras gain. In FIG. 3, e₁ is the edge enhancement value derived from the above method, and e₂ is edge enhancement intensity derived by USM type method. For example, e₂ may be in the following form.

$${e}_{2} ( I ) = {clip}_{max} ( {shrink}_{thr} ( gain \times {{\sum }_{- 2 \leq m \leq 2}}_{- 2 \leq n \leq 2} {E}_{m + 2 , n + 2} {p}_{j - m , k - n} ) )$$

$${shrink}_{thr} ( x ) = \{ \begin{matrix}x + thr & x < - thr \\ 0 & - thr \leq x \leq thr \\ x - thr & thr < x\end{matrix} \\ {clip}_{max} ( x ) = \{ \begin{matrix}- thr & x < - thr \\ x & - thr \leq x \leq thr \\ + thr & thr < x\end{matrix}$$

Here, E is a kernel of a 5×5 linear filter, and gain and thr are user defined values. E and other values are tuned so that this function gives enough contrast gain but produces no Halo artifact. The e₂ value is combined with e₁ value from the above method to make the final output value. For this purpose, e₁ and e₂ may be added. Also, the following equation can be used.

$$e ( I ) = \{ \begin{matrix}{p}_{j , k} + {e}_{1} \\ {p}_{j , k} + {e}_{2}\end{matrix} \begin{matrix}if \vert {e}_{1} \vert > \vert {e}_{2} \vert \\ otherwise .\end{matrix}$$

Using this combined method, local gain contrast and edge sharpening without or with very small Halo artifact may be achieved.

$$e ( I ) = \{ \begin{matrix}{p}_{j , k} + {e}_{1} \\ {p}_{j , k} + {e}_{2}\end{matrix} \begin{matrix}if \vert {e}_{1} \vert > \vert {e}_{2} \vert \\ otherwise .\end{matrix}$$

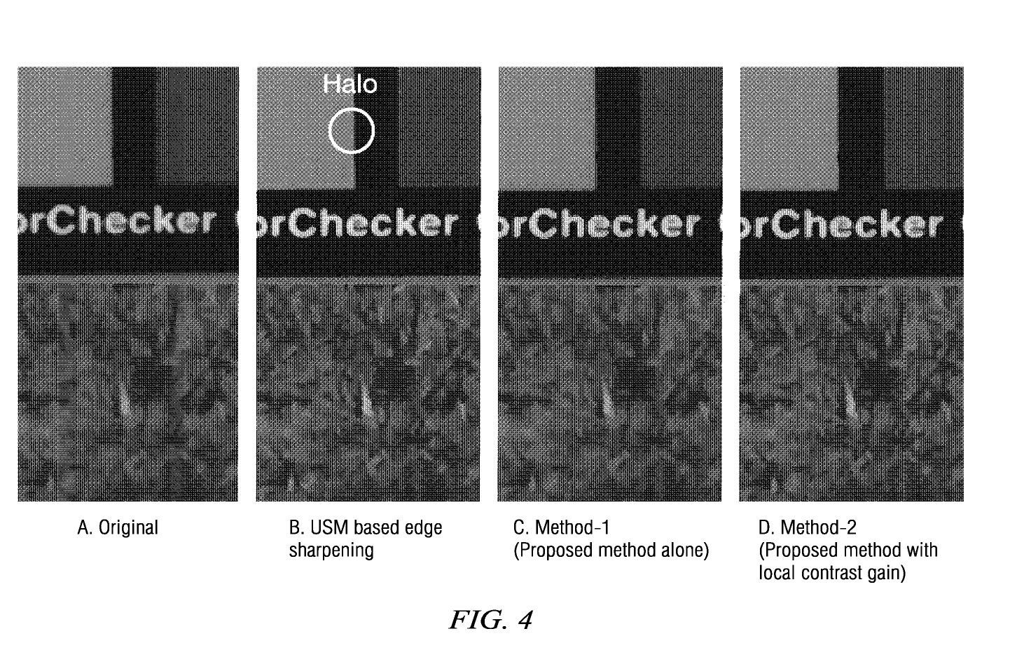

FIG. 4 is an embodiment depicting images improved utilizing USM, edge sharpening and edge sharpening with local contract gain. FIG. 4 shows experimental results of the image sharpening methods. In FIG. 4, A is the original image, and B is processed with USM based edge enhancement technology.

B shows visually higher resolution than A, however, the upper half of B shows strong Halo artifacts too. C shows about the same level of perceptual resolution as B, without Halo artifacts. However, the lower half of C shows less vividness than that of B., because this method does not enhance local contrast. D, on the other hand, shows same level of perceptual resolution as B and D, and same level of vividness as C. D also shows much weaker Halo artifacts than B.

This experimental result shows that the image sharpening methods enhance perceptual image sharpness to the same level as USM based method. In addition, the method shows the same level of vividness as USM based method by tuning the local contrast.

In one embodiment, the image sharpening method and apparatus applies adaptive threshold to USM based edge sharpening, which depends on local activity measurement. By cropping the intensity of USM with the adaptive threshold value, exceeding intensity of edge enhancement is suppressed. The threshold value is adaptively varied depending on the measurement depending on the local details.

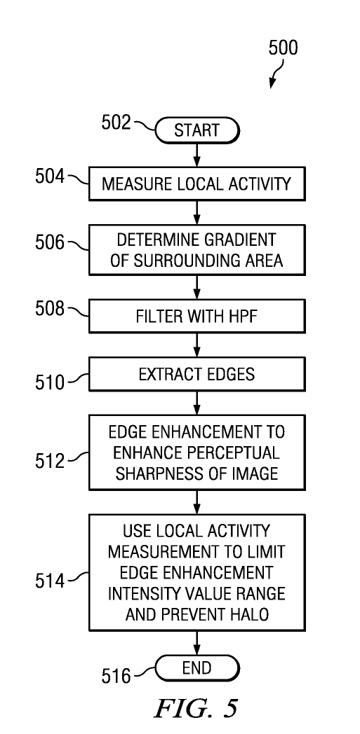

FIG. 5 is an embodiment depicting a flow diagram for a method 500 for edge sharpening. The method 500 starts at step 502 and proceeds to step 505. At step 504, the method 500 measure local activity. At step 506, the gradient of surrounding area is determined. At step 508, the method 500 filters with HPF. At step 510, the edges are extracted. At step 512, enhance edges and, thus, enhance perceptual sharpness of image. At step 514, the method 500 uses local activity measurement to limit edge enhancement intensity value range and prevent halo. The method 500 ends at step 516.

While the foregoing is directed to embodiments of the present invention, other and further embodiments of the invention may be devised without departing from the basic scope thereof, and the scope thereof is determined by the claims that follow.

What is claimed is:

1. A method of a digital signal processor for image enhancement, comprising:
measuring local activity of at least a portion of the image;
utilizing the measured local activity for determining gradient at least a portion of the image;
utilizing the determined gradient to enhance edges in at least a portion of the image; and
utilizing the measured local activity of at least a portion of the image to limit edge enhancement intensity value range and to prevent halo in at least a portion of the image.

2. A digital signal processor for image enhancement, comprising:
means for measuring local activity of at least a portion of the image;
means for utilizing the measured local activity for determining gradient at least a portion of the image;
means for utilizing the determined gradient to enhance edges in at least a portion of the image; and
means for utilizing the measured local activity of at least a portion of the image to limit edge enhancement intensity value range and to prevent halo in at least a portion of the image.

3. A computer readable medium comprising computer instructions, when executed, perform a method for image enhancement, the method comprising:
measuring local activity of at least a portion of the image;
utilizing the measured local activity for determining gradient at least a portion of the image;
utilizing the determined gradient to enhance edges in at least a portion of the image; and
utilizing the measured local activity of at least a portion of the image to limit edge enhancement intensity value range and to prevent halo in at least a portion of the image.
